(19) United States
(12) Patent Application Publication
(10) Pub. No.: US 2015/0183060 A1
(43) Pub. Date: Jul. 2, 2015

(54) METHOD OF MANUFACTURING AN OPTICAL MODULE

(71) Applicants: NTT ELECTRONICS CORPORATION, Kanagawa (JP); NIPPON TELEGRAPH AND TELEPHONE CORPORATION, Tokyo (JP)

(72) Inventors: Toshiki NISHIZAWA, Kanagawa (JP); Yuji MITSUHASHI, Kanagawa (JP); Ryoichi KASAHARA, Tokyo (JP); Ikuo OGAWA, Tokyo (JP)

(21) Appl. No.: 14/642,405

(22) Filed: Mar. 9, 2015

Related U.S. Application Data
(62) Division of application No. 13/467,782, filed on May 9, 2012.

(30) Foreign Application Priority Data
May 13, 2011 (JP) 2011-108655

(51) Int. Cl. B23K 26/32; B23K 26/22; G02B 6/42

(52) U.S. Cl. CPC B23K 26/3233; G02B 6/4212; B23K 26/22

(57) ABSTRACT

A method of manufacturing an optical module, comprising: mounting on a plane of a flat-plate-shaped base having a predetermined thickness: (a) an optical semiconductor package in which an active optical element is air-tightly sealed; (b) a waveguide optical element which wave-guides light from an optical fiber or to an optical fiber; and (c) an optical lens which connects the active optical element and the waveguide optical element; irradiating the plane with laser light at an angle close to horizontal to fix the optical lens using spot welding; covering the optical semiconductor package, the waveguide optical element, and the optical lens, with a frame-equipped lid having a bathtub shape; and fixing the frame-equipped lid onto the plane of the flat-plate-shaped base.

### CROSS-REFERENCED APPLICATION

This application is a Divisional Application of U.S. patent application Ser. No. 13/467,782, filed on May 9, 2012, which is incorporated herein by reference in its entirety.

### BACKGROUND

1. Field of the Disclosure

The present disclosure relates to a method of manufacturing an optical module which transmits or receives an optical signal.

2. Discussion of the Background Art

Conventionally, there has been proposed an optical module which transmits or receives an optical signal (for example, see Patent Document 1). An optical module of Patent Document 1 accommodates an optical element, a base (hereinafter, described as a carrier) on which the optical element is mounted, a lens, and a lens fixing fitting. Module implementation is performed such that the lens and the lens fixing fitting are subjected to spot welding with YAG laser after optically aligned and are fixed on the carrier and that the carrier is installed in a module case.

Patent Document 1: Japanese Patent Application Laid-Open No. 2000-277843

In the optical module of Patent Document 1, the carrier is installed in the module case after implemented outside the module case. Therefore, there has been a problem that implementation takes time. Further, when a subassembly which is optically aligned outside the module case is installed in the module case, the optical axis position is shifted based on a height tolerance of the subassembly. Therefore, it has been difficult to perform optical coupling with a waveguide such as a fiber.

As a method to solve the above problems, it may be considered to perform optical alignment in a package and to perform spot welding with YAG laser on the lens and the lens fixing fitting. However, owing to existence of a frame 118, an irradiation angle of laser light cannot be close to horizontal and laser light is to be irradiated with from an upper side as illustrated in FIG. 4. Then, an optical lens 114 may be subducted in a lens retention holder 117. As a result, optical axis deviation occurs and a yield decreases. In particular, the yield significantly decreases when the optical lens 114 performs inputting and outputting of light at a plurality of ports.

Accordingly, it is aimed to provide an optical module having a structure to prevent occurrence of optical axis deviation at the time of YAG laser welding.

### SUMMARY

disclosure A method of manufacturing an optical module, comprising: mounting on a plane of a flat-plate-shaped base having a predetermined thickness: (a) an optical semiconductor package in which an active optical element is air-tightly sealed; (b) a waveguide optical element which wave-guides light from an optical fiber or to an optical fiber; and (c) an optical lens which connects the active optical element and the waveguide optical element; irradiating the plane with laser light at an angle close to horizontal to fix the optical lens using spot welding; covering the optical semiconductor package, the waveguide optical element, and the optical lens, with a frame-equipped lid having a bathtub shape; and fixing the frame-equipped lid onto the plane of the flat-plate-shaped base.

In particular, an optical module of the present disclosure includes a flat-plate-shaped base having a predetermined thickness; an optical semiconductor package which is mounted on a plane of the flat-plate-shaped base and in which an active optical element is air-tightly sealed; a waveguide optical element which wave-guides light from an optical fiber or to an optical fiber and which is mounted on the plane of the flat-plate-shaped base; an optical lens which connects the active optical element and the waveguide optical element and which is mounted on the plane of the flat-plate-shaped base; and a frame-equipped lid which covers the optical semiconductor package, the waveguide optical element, and the optical lens and which is fixed onto the plane of the flat-plate-shaped base.

Since the optical module of the present disclosure includes the flat-plate-shaped base, the optical semiconductor package, the waveguide optical element, the optical lens and the frame-equipped lid, it is possible to configure the optical module to transmit or receive an optical signal. Here, since the optical module of the present disclosure adopts the flat-plate-shaped base having the predetermined thickness as the base on which the optical semiconductor package, the optical semiconductor package, the waveguide optical element and the optical lens are mounted, it is possible to set an irradiation angle of laser light to be close to horizontal when the optical semiconductor package, the waveguide optical element and the optical lens are fixed to the base while ensuring package stiffness without a frame. Since the irradiation angle of laser light can be set to be close to horizontal when the waveguide optical element and the optical lens are fixed to the base, it is possible to prevent occurrence of optical axis deviation when the optical semiconductor package, the waveguide optical element and the optical lens are fixed to the base. According to the optical module of the present disclosure, it is possible to provide an optical module having a structure which prevents occurrence of optical axis deviation at the time of YAG laser welding.

In the optical module of the present disclosure, the flat-plate-shaped base may be made of kovar, and a chassis of the optical semiconductor package may be made of ceramic.

Since kovar and ceramic have similar linear expansivity, deformation is suppressed even when temperature of the optical semiconductor package or the waveguide optical element is varied. Accordingly, it is possible to prevent optical axis deviation due to temperature variation.

In the optical module of the present disclosure, the predetermined thickness of the flat-plate-shaped base may be not less than 2.25 mm and not more than 5 mm.

Owing to that the thickness of the flat-plate-shaped base is 2.25 mm or more, deformation of the flat-plate-shaped base can be prevented. Further, owing to that the thickness of the flat-plate-shaped base is 5 mm or less, the thickness of the optical module can be set to be 9 mm or less.

In the optical module of the present disclosure, the flat-plate-shaped base may be provided with a flange at an outer edge, and a thickness of the flange may be not less than 0.5 mm and not more than 5 mm.

Owing to that the thickness of the flange is 0.5 mm or more, the optical module can be fixed with sufficient strength while preventing deformation of the flat-plate-shaped base. Further, owing to that the thickness of the flange is 5 mm or less, the thickness of the optical module can be set to be 9 mm or less.

In the optical module of the present disclosure, the plane of the flat-plate-shaped base and an outer wall face of the frame-equipped lid may be subjected to Ni plating.

Since the flat-plate-shaped base is subjected to Ni plating, oxidation can be prevented. Further, since a reflection rate of Ni plating is low, laser welding can be performed so that the optical semiconductor package, the waveguide optical element and the optical lens can be fixed to the flat-plate-shaped base. Further, since the outer wall face of the frame-equipped lid is subjected to Ni plating, the frame-equipped lid can be fixed to the flat-plate-shaped base by laser welding.

In the optical module of the present disclosure, it is preferable that the flat-plate-shaped base has a larger area than that of the optical semiconductor package.

The present disclosure provides a sufficient installation space for the optical lens and the waveguide optical element, optical axis adjustment of the optical lens and the waveguide optical element is performed easily and laser welding is performed easily. Further, since it is possible to arrange a plurality of optical lenses or to arrange a plurality of waveguide optical elements, variations of optical design to be mounted to an optical module can be increased.

Here, the abovementioned disclosures can be combined to the extent possible.

According to the present disclosure, it is possible to provide an optical module having a structure to prevent occurrence of optical axis deviation at the time of YAG laser welding.

### BRIEF DESCRIPTION OF THE DRAWINGS

FIG. 1 is a top view of an optical module according to the present embodiment.

FIG. 2 is a sectional view at A-A′ of the optical module according to the present embodiment.

FIG. 3 illustrates an example of an irradiation angle of laser light in the optical module according to the present embodiment.

FIG. 4 illustrates an example of an irradiation angle of laser light in a conventional optical module.

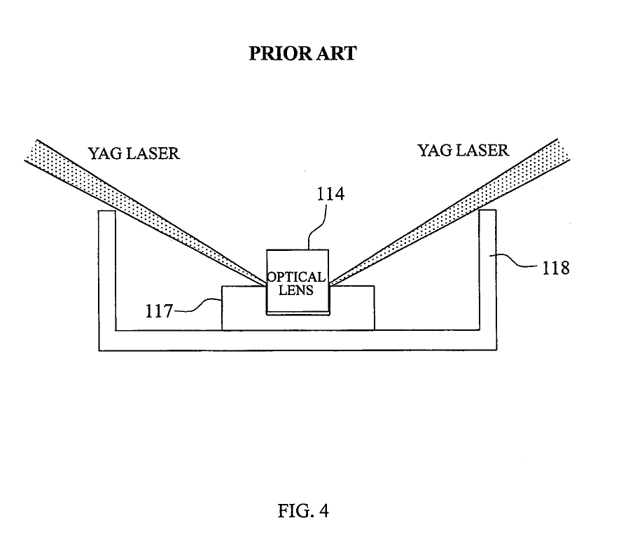

### DETAILED DESCRIPTION OF THE PREFERRED EMBODIMENT

Embodiments of the present disclosure will be described with reference to the attached drawings. The embodiments described below are examples to embody the present disclosure. The present disclosure is not limited to the following embodiments. Here, in the specification and drawings, structural components having the same numeral denote the same entity.

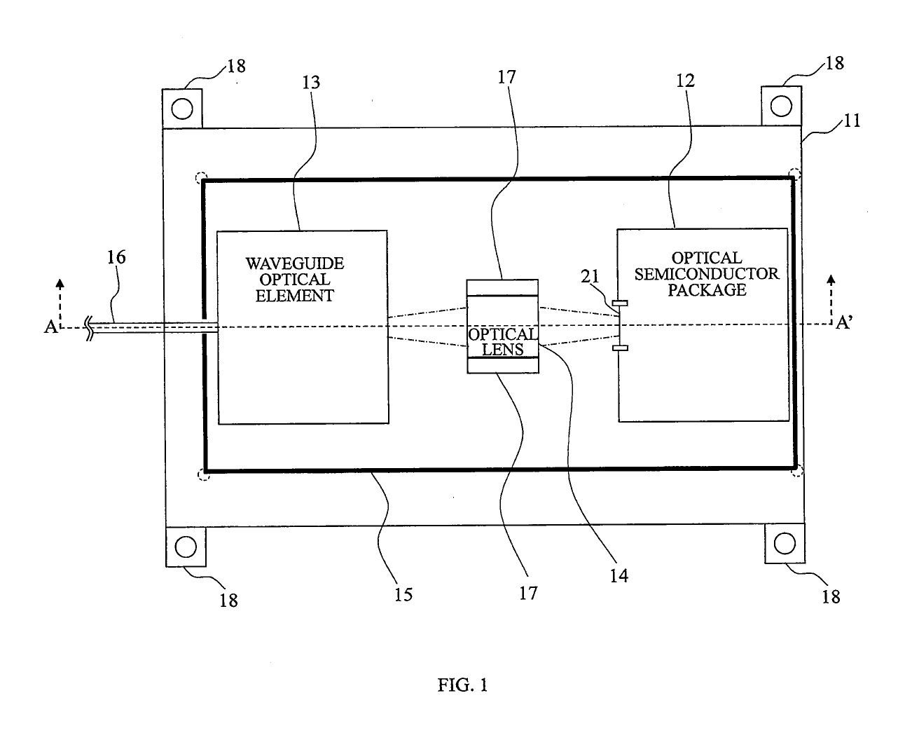

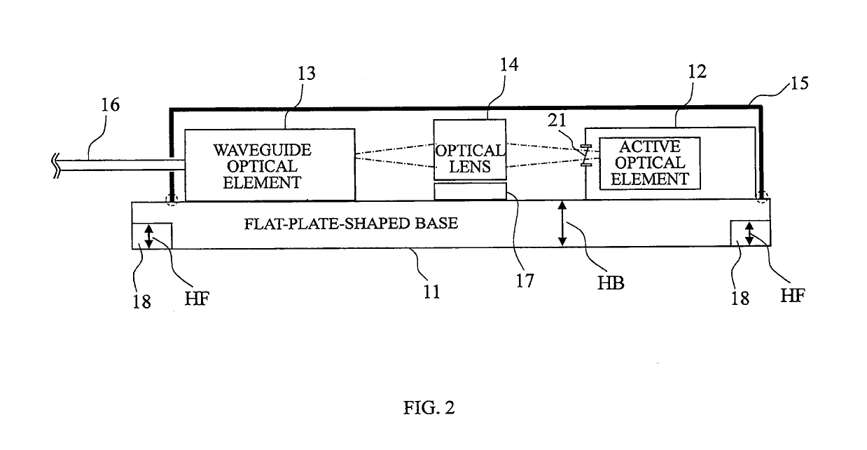

FIGS. 1 and 2 illustrate an example of an optical module according to the present embodiment. FIG. 1 is a top view of the optical module according to the present embodiment and FIG. 2 is a sectional view at A-A′. The optical module according to the present embodiment includes a flat-plate-shaped base 11, an optical semiconductor package 12, a waveguide optical element 13, an optical lens 14, a frame-equipped lid 15, a lens retention holder 17, and a flange 18.

The optical module according to the present embodiment can configure an integrated receiving front end (FE) module which supports optical phase modulation, that is, a quadrature phase shift keying (QPSK) transmission system or a dual-polarization quadrature phase shift keying (DP-QPSK) transmission system, as being associated with further communication traffic increase. A planar lightwave circuit (PLC) receiving optical circuit to be used for the transmission systems, which is called a delayed interferometer (DLI) or a dual polarization optical hybrid (DPOH), converts difference in phase state of optical signals into difference in optical intensity. The waveguide optical element 13 functions as the PLC receiving optical circuit. Then, a photo diode (PD) in the optical semiconductor package 12 capable of detecting only optical intensity difference receives an optical signal which is converted into optical intensity difference by the PLC receiving optical circuit. A transimpedance amplifier (TIA) in the optical semiconductor package 12 amplifies an electric signal demodulated by the PD by current/voltage conversion and outputs it as a high-frequency electric signal. In this manner, the optical semiconductor package 12 may accommodate a circuit such as a TIA in addition to active optical elements such as a laser diode (LD) and a PD. In the following, details of the optical module according to the present embodiment will be described.

The waveguide optical element 13 and optical components such as the optical lens 14 are mounted on the flat-plate-shaped base 11 which has a sufficiently larger area than that of the optical semiconductor package 12. To enable spot welding such as YAG laser of the optical components such as the optical lens 14, the flat-plate-shaped base 11 is not Au-plated but is Ni-plated. Further, the flat-plate-shaped base 11 not having a frame at a side face has a predetermined thickness to ensure package stiffness. Owing to ensuring package stiffness, the flat-plate-shaped base 11 is prevented from being deformed even if jointly fixed to a printed board when assembling the optical module to an optical receiving apparatus, so that excellent optical characteristics can be obtained.

Here, it is preferable that the flat-plate-shaped base 11 is made of kovar. In this case, it is preferable that the predetermined thickness HB is not less than 2.25 mm and not more than 5 mm. Owing to that the thickness HB of the flat-plate-shaped base 11 is 2.25 mm or more, the flat-plate-shaped base 11 is prevented from being deformed even if jointly fixed to a printed board. Further, since the thickness HB of the flat-plate-shaped base 11 is 5 mm or less, the thickness of the optical module can be set to be 9 mm or less. Accordingly, it is possible to be compliant to standards defined by the Optical Internetworking Forum (OIF).

Further, when the flat-plate-shaped base 11 is made of kovar, it is preferable that a chassis of the optical semiconductor package 12 is made of ceramic. This is because difference in linear expansivity is small between kovar and ceramic.

An active optical element such as a light-emitting element and a light-receiving element is air-tightly sealed in the optical semiconductor package 12 and a transmission window 21 for transmitting an optical signal is arranged at the chassis. The active optical element is fixed to an active optical element accommodation portion of the optical semiconductor package 12 with solder or resin. To support an optical phase modulation system, a plurality of elements is arrayed as the active optical elements. The number of arrays is varied in accordance with a transmission system. It may be two arrays, four arrays, or eight arrays. Alternatively, it is also possible to arrange a plurality of elements which are not arrayed. The arrays may be arranged as evenly spaced or unevenly spaced.

A metal for sealing is arranged at an upper part of the active optical element accommodation portion to be capable of air-tightly sealing the active optical elements by seam welding, resistance welding, laser welding or the like using a metal-made lid. For example, N₂ gas is used as replacement gas.

To prevent reflection of an optical signal, the transmission window 21 is subjected to anti-reflection (AR) coating, and further, is installed as angled against the optical signal. It is preferable that material of the transmission window 21 is sapphire or borosilicate glass having small difference in linear expansivity from ceramic which is used for the chassis.

The optical lens 14 connects the optical semiconductor package 12 and the waveguide optical element 13. The active optical element in the optical semiconductor package 12 and an optical signal of the waveguide optical element 13 are optically coupled by the optical lens 14. The optical lens 14 may adopt a finite system of one piece or a confocal system of two pieces. The optical lens 14 may be one lens having a predetermined effective diameter or a lens array.

The waveguide optical element 13 wave-guides light to an optical fiber 16 or light from the optical fiber 16. The waveguide optical element 13 may be configured as a planar lightwave circuit (PLC) or as an optical fiber array. In a case that a light-emitting element is used as the active optical element and optical modulator is used as the waveguide optical element 13, an integrated transmitting module can be configured as an optical module. In a case that a light-receiving element is used as the active optical element and an optical demodulator is used as the waveguide optical element 13, an integrated receiving module can be configured as an optical module.

The waveguide optical element 13 includes one or plural input waveguides. In addition, the waveguide optical element 13 may include one or plural output waveguides. The number of arrays is the same as the number of arrays of the optical semiconductor package 12. Array intervals may be same as or different from the array intervals of the optical semiconductor package 12.

In a case that the waveguide optical element 13 is a PLC or an optical fiber array, since various resins are used, outgas from the resins can influence the active optical element. However, in the optical module according to the present embodiment, since only the optical semiconductor package 12 is separately sealed, there is no influence of outgas from the resins to the active optical element. Accordingly, the active optical element can perform continuously stable operation.

The frame-equipped lid 15 has a bathtub shape to cover the optical semiconductor package 12, the waveguide optical element 13, and the optical lens 14. The frame-equipped lid 15 may be made of metal or resin material. The frame-equipped lid 15 is subjected to Ni plating at an outer wall face to be capable of being subjected to spot welding such as YAG laser with the flat-plate-shaped base 11.

A flange 18 for jointly-fixing to a printed board may be arranged at an outer edge of the flat-plate-shaped base 11. When the flange 18 is made of kovar, it is preferable that the thickness HF of the flange 18 is not less than 0.5 mm and not more than 5 mm. Owing to that the thickness HF of the flange 18 is 0.5 mm or more, the optical module can be fixed with sufficient strength without causing deformation of the flat-plate-shaped base 11 even if jointly fixed to a printed board. Further, since the thickness HF of the flange 18 is 5 mm or less, the thickness of the optical module can be set to be 9 mm or less. Accordingly, it is possible to be compliant to standards defined by the OIF.

The optical semiconductor package 12 and the waveguide optical element 13 are fixed to predetermined positions with solder, resin, laser or the like on the flat-plate-shaped base 11. The optical lens 14 is held by the lens retention holder 17 and is fixed to the flat-plate-shaped base 11 with spot welding such as YAG laser. In a fixing procedure, first, the lens retention holder 17 and the flat-plate-shaped base 11 are fixed, then they are fixed on a direction perpendicular to an optical signal. Next, the optical lens 14 and the lens retention holder 17 are fixed by spot welding such as YAG laser. Conventionally, there has been occurrence of deviation at optical coupling owing to an irradiation angle of laser light.

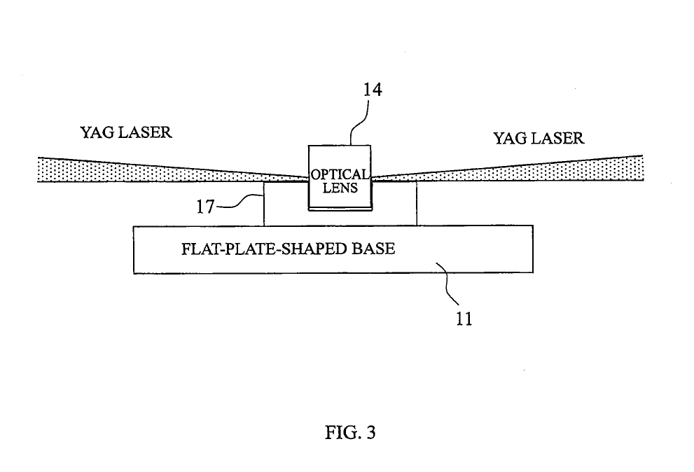

FIG. 3 illustrates an example of an irradiation angle of laser light in the optical module according to the present embodiment. Since the flat-plate-shaped base 11 without a frame is arranged in the optical module according to the present embodiment, the irradiation angle of laser light can be close to horizontal, as illustrated in FIG. 3. As a result, the optical lens 14 is not subducted at the time of fixing the optical lens 14 and the lens retention holder 17 and occurrence of optical axis deviation is prevented. Further, due to arrayed optical coupling, preventing occurrence of optical axis deviation provides major improvement of a yield.

After the optical installation is completed, the frame-equipped lid 15 is fixed onto a plane of the flat-plate-shaped base 11. Thus, the optical module according to the present embodiment has a double cover structure in which the optical semiconductor package 12 is further covered with the frame-equipped lid 15. The frame-equipped lid 15 is fixed to the flat-plate-shaped base 11 by spot welding such as YAG welding, resin fixing, solder fixing, or the like. Owing to that the frame-equipped lid 15 is fixed, package stiffness can be ensured.

As described above, the optical module according to the present embodiment can obtain excellent optical coupling characteristics while stably performing difficult arrayed optical coupling.

The present disclosure can be applied to information communication industry.

What is claimed is:

1. A method of manufacturing an optical module, comprising:
mounting on a plane of a flat-plate-shaped base having a predetermined thickness:
(a) an optical semiconductor package in which an active optical element is air-tightly sealed;
(b) a waveguide optical element which wave-guides light from an optical fiber or to an optical fiber; and
(c) an optical lens which connects the active optical element and the waveguide optical element;
irradiating the plane with laser light at an angle close to horizontal to fix the optical lens using spot welding;
covering the optical semiconductor package, the waveguide optical element, and the optical lens, with a frame-equipped lid having a bathtub shape; and
fixing the frame-equipped lid onto the plane of the flat-plate-shaped base.

2. The method according to claim 1, wherein said flat-plate-shaped base is made of kovar; and a chassis of the optical semiconductor package is made of ceramic.

3. The method according to claim 2, wherein the predetermined thickness of the flat-plate-shaped base is not less than 2.25 mm and not more than 5 mm.

4. The method according to claim 1, wherein the flat-plate-shaped base is provided with a flange at an outer edge; and a thickness of the flange is not less than 0.5 mm and not more than 5 mm.

5. The method according to claim 2, wherein the flat-plate-shaped base is provided with a flange at an outer edge; and a thickness of the flange is not less than 0.5 mm and not more than 5 mm.

6. The method according to claim 3, wherein the flat-plate-shaped base is provided with a flange at an outer edge; and a thickness of the flange is not less than 0.5 mm and not more than 5 mm.

7. The method according to claim 1, wherein the plane of the flat-plate-shaped base and an outer wall face of the frame-equipped lid are subjected to Ni plating.

8. The method according to claim 2, wherein the plane of the flat-plate-shaped base and an outer wall face of the frame-equipped lid are subjected to Ni plating.

9. The method according to claim 3, wherein the plane of the flat-plate-shaped base and an outer wall face of the frame-equipped lid are subjected to Ni plating.

10. The method according to claim 4, wherein the plane of the flat-plate-shaped base and an outer wall face of the frame-equipped lid are subjected to Ni plating.

11. The method according to claim 1, wherein the flat-plate-shaped base has a larger area than that of the optical semiconductor package.

12. The method according to claim 2, wherein the flat-plate-shaped base has a larger area than that of the optical semiconductor package.

13. The method according to claim 3, wherein the flat-plate-shaped base has a larger area than that of the optical semiconductor package.

14. The method according to claim 6, wherein the flat-plate-shaped base has a larger area than that of the optical semiconductor package.

15. The method according to claim 10, wherein the flat-plate-shaped base has a larger area than that of the optical semiconductor package.
